(19) United States
(12) Patent Application Publication
(10) Pub. No.: US 2026/0179125 A1
(43) Pub. Date: Jun. 25, 2026

(54) SYSTEMS AND METHODS FOR RAPIDLY GENERATING ORIGINAL, TIMELY, AND TAILORED CONTENT

(71) Applicant: FrontRow Sports LLC, Topsfield, MA (US)

(72) Inventors: Rolando Rabines, Topsfield, MA (US); Rand Anderson, Manchester, NH (US)

(73) Assignee: FrontRow Sports LLC, Topsfield, MA (US)

(21) Appl. No.: 19/425,393

(22) Filed: Dec. 18, 2025

Related U.S. Application Data
(60) Provisional application No. 63/735,976, filed on Dec. 19, 2024.

(51) Int. Cl. G06Q 30/0241; G06Q 10/42

(52) U.S. Cl. CPC G06Q 30/0276; G06Q 10/42

(57) ABSTRACT

A system for rapidly generating tailored advertising content for a user is described. In some embodiments, a social media application may be configured to generate a network of interconnections between users of the social media application and to generate a model based on a user's activity and the generated network which represents a user's real-time interest. The social media application may be able to process a stream of signals representing events occurring during a live sporting contest and determine, based on the model of a user's real time interests, that an event in a live sporting contest has occurred which will be interesting to that user. The system may then generate a prompt for a RAG LLM to create tailored advertising content for the user based on the interesting moment and deliver the content to the user within a short window of that event.

### CROSS REFERENCE TO RELATED APPLICATIONS

This application claims the benefit of priority under 35 U.S. C § 119(e) of U.S. patent application Ser. No. 63/735,976 filed Dec. 19, 2024 which is hereby incorporated by reference in its entirety.

### BACKGROUND

Social media applications have become one of the primary ways that users interact with each other and consume media. Today there are social media applications that provide infrastructure for allowing the presentation of media collections with automated interactive advertising. In one example, U.S. Pat. No. 11,783,369 discloses a system that automatically generates interactive advertising data. In one example, a client receives content for. The client also receives advertising data. After presentation of some of the content, the system will display some of the advertising data. There are interaction elements that are presented on the client device and are controllable via user inputs. The system can record the interactions with the advertising data and the interactions may be used to manage the presentation of future advertising data. In one example, the disclosed system generates user avatars that move across the screen and carry ads for the user to see.

Although such interactive advertising systems, that are built into social media applications can work well for presenting content that is of interest to a user, the development of such advertising content can be expensive and time consuming. As such, existing systems tend to limit interactive advertising to simple elements of entertaining media, such as these avatars that hold and carry messages across a screen or display so that the user can see them. To make it more attention grabbing, in some embodiments the avatars are selected to look like users of the social media network so that a user will see an ad being moved across the screen by an avatar that may look like a friend in their social network.

Although these interactive ads can be humorous and can attract the attention of a user, they are, after a short period of exposure, often found to be distracting. The moving icons and avatars quickly become repetitive and no longer attract the interest of a user. Quality content that can attract the interest of a user is valuable but hard to generate. The difficulty in generating such content means that with existing social media applications quality content is too slow to be developed and too expensive to develop. Further, the interest of a user is variable over time, a user may be generally interested in a topic, for example the Boston Celtics NBA team, but they may not be interested to a level which could prompt action or allow them to be motivated by advertising at all times of the day.

Therefore, there is a need for improved systems that provide, within social media applications, content that will attract the attention of the user and can support an advertising program and can present the content in a manner that is less distracting and less likely to interrupt the user's primary experience, which may be viewing content or otherwise engaging with the social media application.

### SUMMARY

The systems and methods disclosed herein include, in one embodiment, a computer-implemented process for producing advertising content that is tailored to the present interests of the users. The systems and methods described herein can rapidly generate content of the type that will capture the interest of a user and will be originally generated such that it avoids the repetition of prior systems.

In one embodiment, the systems and methods described herein include systems that rapidly generate relevant content. It is a realization of the inventors that social media networks create data graphs that record interests of a user. One example of this can be a sports related social media app and the data graph of the user's interest can include the identity of sports teams of interest to the user, the identity of players of interest to the user, friends of the user that share an interest in these teams and players, and other such information.

It is a further realization of the inventors that during the occurrence of a contest, such as a sporting event like a basketball game, a user of a social media application of the type described herein indicates a clear interest in a particular contest, such as a basketball game occurring at 7:30 pm at Thursday September 10^{th}, by offering an opinion to his or her social network about the outcome of this game. Content generated about this event will be of interest to the user.

External factors play a role in reminding people of topics which they are generally interested in. For example, some user's may watch pregame sports news coverage, which prompts them to think of a favorite sports team, such as the Celtics, while others may be interested in sports talk radio programs which they consume during their morning commutes. The systems and methods described herein provide a way to personalize prompting users of their interests in a social media app, based on the user expressing a current, timely interest in a topic typically triggered by the user making a Take, to determine a likely predisposition of a user to be interested in a topic at a particular time of day.

In one embodiment the systems and methods described herein include a social media application that develops a data network that shows the network of relationships between a user and different entities such as sports teams and players as well as friends associated with this particular user. The systems and methods described herein can include a prompt generator capable of generating prompts of the type employed to prompt a large language model content generation system to generate content. The prompt generators described herein can traverse the data network of interests and friends of a particular user to develop a table of terms that include the interests of that user. The prompt generator as described herein can further include a scheduler that monitors the commencement and finish of a contest, such as a basketball game. The scheduler can also track a pregame period that indicates a time period prior to the commencement of the contest, and a period that indicates a period of time that occurs after the contest is finished and a winner has been declared. The systems and methods described herein will include a prompt generator that will employ the terms of interest to the user found by traversing the data network of interests of that user and employ those terms, as well as terms about the relevant contest, to develop a prompt that can be used for prompting a generative AI system to produce humorous content that is contextually relevant to the interests of the user, and the sporting event taking place. In this way, the systems described herein can provide social media applications which will include advertising content that is timely and contextually relevant to the interests and an ongoing contest of interest, to a user. Further, by using generative AI systems, of the type available on the market such as DALL-E, Midjourney, or Claude, the social media applications described herein can rapidly generate advertising content that is contextually relevant to the user.

In one embodiment, the systems for generating advertising content for a social media application comprises a social media application having a processor configured to generate a network of relationships that records interconnections between the users of the social media application where each user in the network has a set of recorded interests. The system processes the network of relationships to generate a dynamic user data filter having a time-varying model of a real-time interest of a user. The system is further configured to monitor a real-time signal stream having signals representing events related to a sporting competition, and apply the user data filter to the real-time signal stream to identify a set of signals representing an event which will interest the user at the time the event was detected at an event detection node. The analysis at the event detection node generates a peak attention signal which indicates an event has occurred in a sporting contest which will likely be interesting to the user. The system may also include a prompt generator configured to process the peak attention signal as input and use it to generate one or more prompts to a generative AI system. The one or more prompts are contemporaneous with the time of the peak attention signal and based on the interests of the user and a second user who is part of the network of relationships of the user, and the generative AI system is configured to generate engaging content in response to the prompt and that content can be joined to advertising information.

### BRIEF DESCRIPTION OF DRAWINGS

The foregoing and other objects and advantages of the systems and methods described herein will be appreciated more fully from the following further description thereof, with reference to the accompanying drawings wherein;

FIG. 1 depicts pictorially a social media application having a data graph of user interests.

FIG. 2 depicts a process for generating advertising content.

FIG. 3 depicts an example of prompt generator for use with a social media application.

FIG. 4 depicts an example of a table of user interests.

FIG. 5 depicts an example of a table of a game/contest data.

FIG. 6 depicts an example of a table of user discussions about a game/contest.

FIG. 7 depicts data table being generated and updates during a contest.

FIG. 8 depicts a flow chart of a process to generate advertising content by generating prompts based on a social network and game data.

FIG. 9 depicts a block diagram of an embodiment of the system for generating a query or series of queries.

FIG. 10 depicts a block diagram of an embodiment of the system for evaluating the relevance of a moment to a particular user.

FIG. 11 depicts a block diagram of an embodiment of the system for generating and delivering AI content.

### DETAILED DESCRIPTION

To provide an overall understanding of the systems and methods described herein, certain illustrative embodiments will now be described, including a system that generates content for a social media application. However, it will be understood by one of ordinary skill in the art that the systems and methods described herein can be adapted and modified for other suitable applications and that such other additions and modifications will not depart from the scope hereof.

Certain embodiments of the systems and methods described herein will include social media applications that include an internal prompt generator. The prompt generator is capable of traversing data graphs or data tables constructed from such data graphs, that represent interests and social relationships of a user of the social media application. For example, a user of a social media application, such as an application that allows sports fans to exchange information about an upcoming game, can include a data graph that represents the interests of that user. The interests of that user will be the types of things that typically are associated with sports related social media applications. That could include various teams that the user supports, as well as teams that the user considers rivals, players that the user supports or considers a rival, and the network of friends with which that user shares information, commentary, and has other interactions. The prompt generators described herein are capable of traversing the data graphs that contain information representing the interests of the user and information representing the social network of the user within the social media application. Typically, the prompt generator operates during a particular time period. That time period typically relates to the period during which a contest, typically a sporting event, takes place. So for example, the prompt generator may operate shortly before a game begins, during the course of that game, and after that game when a winner is actually determined. Further, the prompt generator may determine, based on the traversal of the data graphs, that a user is interested in various topics at a particular time of day, and generate the prompts for that specific time.

In the systems and methods described herein, the social media application presents the user with a question. That is the social media application poses a question to the user about an upcoming game. In certain embodiments the social media application generates these questions by analyzing possible outcomes that can take place or typically will take place during a contest. For example, the social media application may analyze whether or not the data related to an upcoming contest between the Boston Celtics and the New York Knicks suggest that Jason Tatum will score at least 5 three-point shots. If the probability for Mr. Tatum scoring 5 3-point baskets is somewhere around 50%, that is it is essentially as likely to occur as it is likely to not occur, the social media app can determine that this is a good and interesting question to pose as the outcome is not certain. The systems and methods described herein can pose a question to a user such as will Mr. Tatum make more than five 3-point baskets today in the contest against the Knicks. In one embodiment, the social media presents this information in a format that allows the user to either select “yes” or “no”. That is the user can support Mr. Tatum in matching or exceeding the 5 3-point baskets or can vote against the success of Mr. Tatum in achieving that goal. The answer provided by the user is deemed to be a Take. A Take indicates that the user is interested in this particular question and this particular game. As such, the systems and methods described herein have input from a user indicating some interest by the user in this question about Mr. Tatum's performance and the overall game taking place between the Celtics and the Knicks.

In the systems methods described herein, the Take provided by the user can be posted so that friends of the user within the social media network and identified within the data graph of friends associated with this user, can receive notice that the user has either supported or voted against the success of Mr. Tatum in this contest. Those users seeing this indication of support or challenge to Mr. Tatum can reply indicating whether they, the friend, also agree that Mr. Tatum will succeed or fail as the first user has indicated or they can challenge the first user and indicate that they, the friend, believe that Mr. Tatum will perform differently than the first user has indicated. All this information can be stored within a data graph representing the network of relationships associated with that first user.

The prompt generator can analyze the data graph representing this network of relationships associated with the first user and generate a data table of terms relevant to these interests. The prompt generator may use the terms within this data table to develop a prompt that could be forwarded to a generative AI system. The prompt may be formulated to direct the generative AI system to create humorous content that builds on and incorporates the interests of the user including, for example, the teams they like, players they like and whether or not positions they have taken, that is their Takes, have been supported or challenged by friends of theirs within the network of relationships.

The prompt generator can further direct the generative AI system to incorporate, within the generated content, advertising information so that a humorous advertisement relevant to the interests of a user may be presented to the user at a time when the user is likely to be interested in the subject matter of the generated content, such as during the sporting event. The content may be presented to the user as well as other users identified as friends of this first user according to the data graph of network relationships. In this way, the systems and methods described herein can rapidly generate engaging content that is contextually relevant to a user, as the user has indicated their interest in this particular area during this time period, which is a limited time period, where the interest is relevant. That is because the user has indicated they are interested, in this example, in how Mr. Tatum will do for this particular game. Thus, during the course of this game, the prompt generator will direct the generative AI system to create user content that builds on these interests which occur during this time so that fresh, original, and engaging content is presented to the user during this contest.

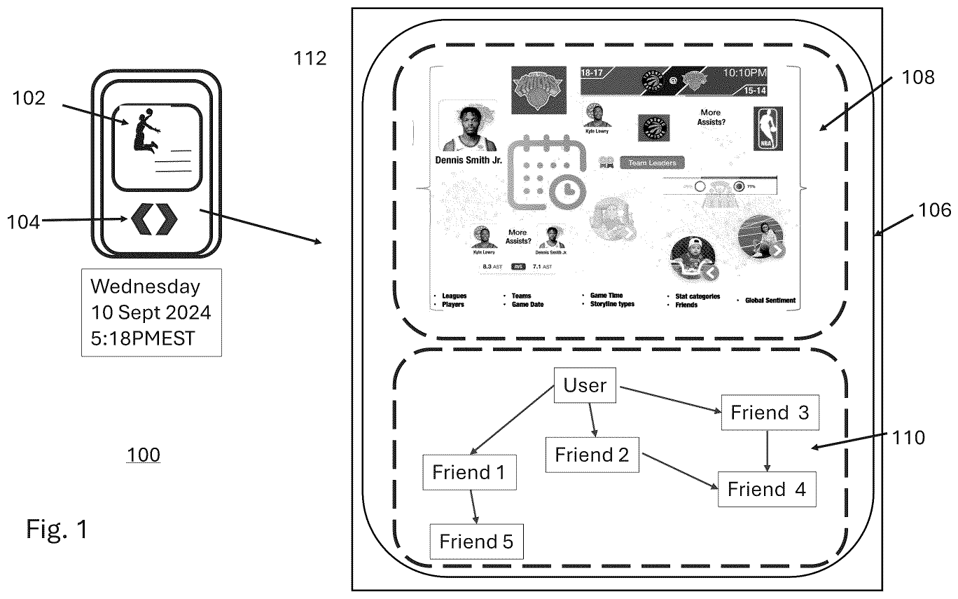

FIG. 1 depicts a system 100 that is a social media application of the type that can be employed with the systems and methods described herein. In particular, FIG. 1 presents a pictorial representation of a social media application 100 that presents a question to a user. In this case the question is presented with a graphic image 102 and with a user interface 104 that allows the person receiving the question, that is to whom the question is posed, to indicate whether or not they agree or disagree with the proposition proposed by the question 102. This kind of social media interaction allows for users to get a quick and simple question posed to them, somewhat like a short quiz or an opinion poll, and they can enter their view very quickly about the question they've been asked. In this example, the user is being presented a question by graphic 102 as to whether or not Mr. Dennis Smith Jr. will score 43 field goals tonight in a contest between the Knicks and the Toronto Raptors. The user interface 104 allows for an easy swipe interaction to take place so that the user can swipe left or right to indicate whether or not they agree or disagree with the proposition or the question posed in the image 102. The user's indication as to whether they agree or disagree is transmitted to the system 112 where it is recorded and used to make social media content that can be presented to friends of the user to involve them in the user's interest and thoughts as to Mr. Smith's expected performance tonight in the contest between the Knicks and the Raptors.

FIG. 1 also shows that the question 102 posed to the user is set at a particular time, in this example Wednesday 10 Sep. 2024 at 5:18 pm Eastern Standard Time. As the contest between the Raptors and the Knicks will take place at 10:10 PM that night 10 Sep. 2024, this question was posed during a period of time that can be deemed “pregame”. As will be discussed further below, the systems and methods described herein can include a prompt generator that has a scheduler that will generate prompts for a generative AI system according to a schedule that is related to the relevancy of a user's attention during a specific time period. Typically, this means that a user offering Takes about a particular question such as the question posed in 102, for tonight's game will have some interest in the subject matter of tonight's game during the period of time that the game takes place. It is during that period of time, that is called gameplay, as well as a reasonable period of time before gameplay that is called pregame and a reasonable period of time after gameplay that is called postgame, that the prompt generator of the type described herein will generate prompts for the generative AI content generator. FIG. 1 further depicts that the system 112 includes a data graph 106 that includes a data graph of topics of interest to the user 108 and a data graph of other users of the social media application that are friends with the user that is answering the Take 102. The system 112 may identify, based on the data graph 106, that a user shows interest in making Takes at a particular time of day. For example, while many users may generally make Takes in the hour leading up to the start of the contest that interests them, another user may have made a number of takes at 11:00 am for an evening game. The system 112 may identify that this particular user shows interest in a team at that time of day, and prompt the user to make a Take at the time of day that they commonly express interest in the upcoming game.

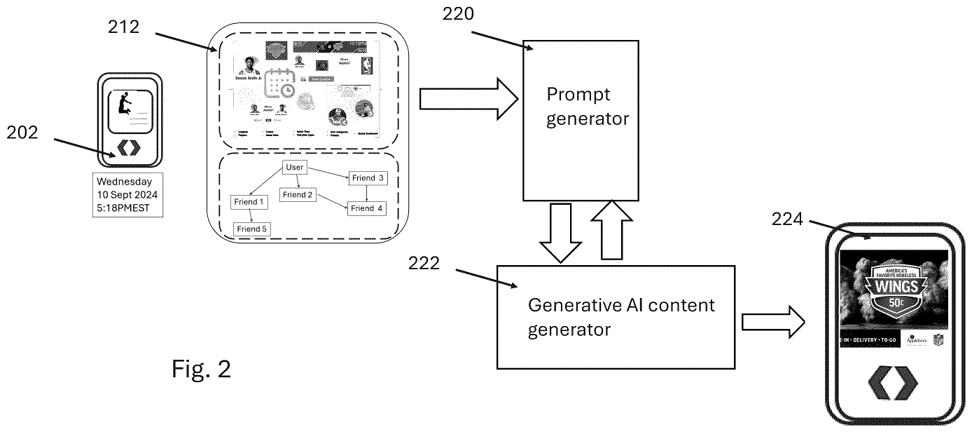

FIG. 2 depicts one example of a system and method as described herein. The system 200 includes the system FIG. 1 as depicted above that has a system that will propose questions 202 and the system 212 that organizes and runs data graphs. It is further depicted in FIG. 2, the system 200 includes a prompt generator 220 and a generative AI content generator 222. The prompt generator 220 interacts with the data graph system 212 to generate prompts that are useful for the generative AI content generator 222 to generate content such as the depicted content 224. As will be described in more detail herein the prompt generator 220 traverses the data graphs managed by the system 212 to identify terms such as team names, player names, past games where a user has participated by giving a Take on a particular outcome for that game, and information from the social network 210 that stores information about those members of the social network that are friends with this user and also stores information about prior interactions between the user and the user's friends as indicated by the data graph 210. For example, the data graph 210 can store information that indicates a user had a particular Take on a certain question, such as whether or not Mr. Smith would make a certain number of field goals in the game between the Raptors and the Knicks, and note that a friend within the network 210 challenged the user's Take on that contest. For example, the user's friend may have indicated that they do not believe that Mr. Smith is going to make that number of field goals in contrast to the user's indication that they, the user, believed Mr. Smith would make that number of field goals.

The depicted example prompt generator 220 traverses the graphs of system 212 and generates data tables that indicate the topics and people of interest to that particular user. The prompt generator 220 employs the data from these tables to generate prompts which are provided to the generative AI content generator 222. The generative AI content generator 222 can also access data from the table generated by the prompt generator 220 and will operate on the prompt created by the prompt generator 220 and data from that data table to create content such as the depicted content 224.

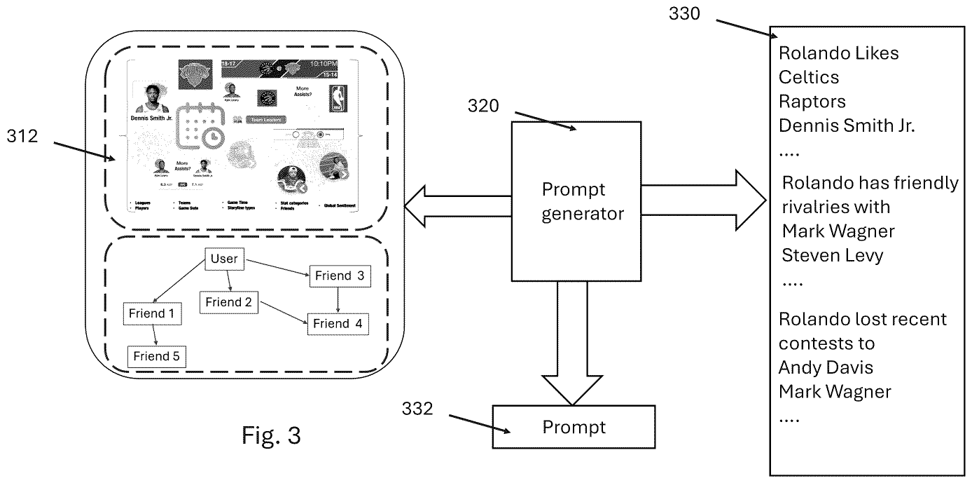

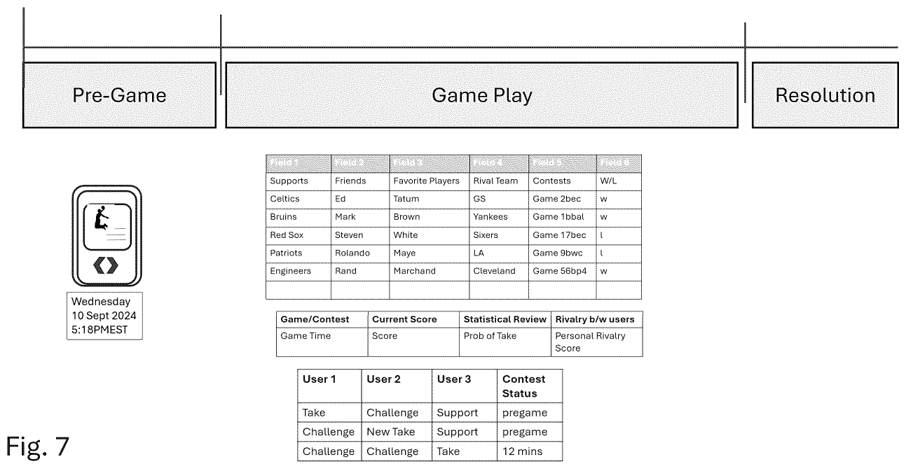

FIG. 3 depicts in more detail the operation of the prompt generator. In particular, FIG. 3 depicts the system 312 interacting with the prompt generator 320. The prompt generator 320 can access the data graphs within the system 312 and traverse them to go ahead and build the table 330. The table 330 in this example discusses content that's of interest to the user such as teams the user likes and players the user likes, as well as information about friendly rivalries this user has with friends in their social network as indicated by the data graph representing that social network. Other information can include recent contests that the user has won or lost versus friends of that user as indicated by the data graph. In any case, the prompt generator 320 will traverse the graphs in system 312 build out the table 330 and employ that table 330 to create a prompt 332. The prompt 332 will be tied to the interests and likes of the user and typically the prompt generator 320 will have a scheduler that generates these prompts during the time period associated with the contest of interest. That is, as we continue with the example from above, the prompt generator 320 will have a scheduler that generates prompts 332 built from the data of table 330 during the pregame, gameplay, and postgame associated with the basketball game between the Raptors and the Knicks, a game for which the user has offered a Take and therefore seems to have some interest in this game, the player Dennis Smith Jr., and the competition between the Knicks and the Raptors. As such the prompt generator 332 can generate a prompt using terms and relationships that are relevant to the user the scheduled time. The scheduler typically identifies a pregame and a postgame period, as will be depicted more in FIG. 7, and typically the scheduler will have the pregame time period run for an hour to about a day before the contest and the postgame period will run between an hour and 3 hours after the game has resolved.

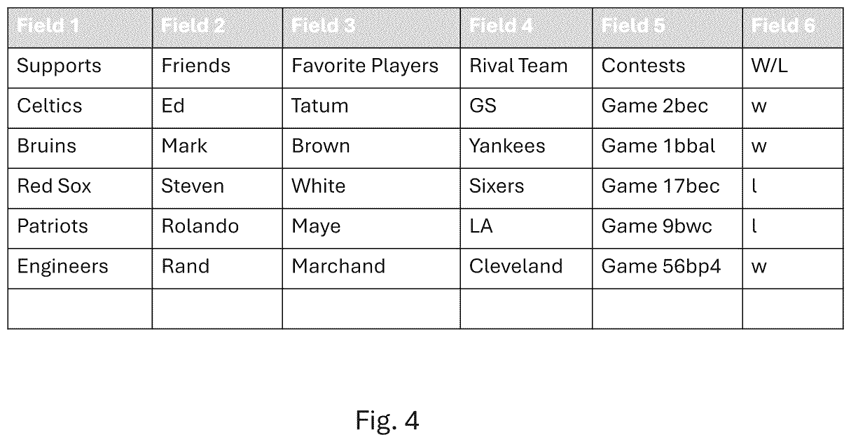

FIG. 4 depicts in more detail one table of the type that could be generated by the prompt generator. In particular, FIG. 4 depicts a table that includes several data fields. The data fields can include teams that the user supports, friends of the user as identified in the data graph representing the friend network of this user, players that are of interest to this particular user, rival teams that the user seems to root against, contests that have been recently played that the user has shown interest in and given a Take to, such as indicating whether or not they believe or do not believe Mr. Smith will hit a certain number of field goals in a particular game between the Knicks and the Raptors, and a win-lose indication indicating whether or not for that particular contest the user was correct or incorrect and in particular whether or not a friend such as Mark or Stephen indicated that they challenged the position of the user and thus the user either won or lost that challenge.

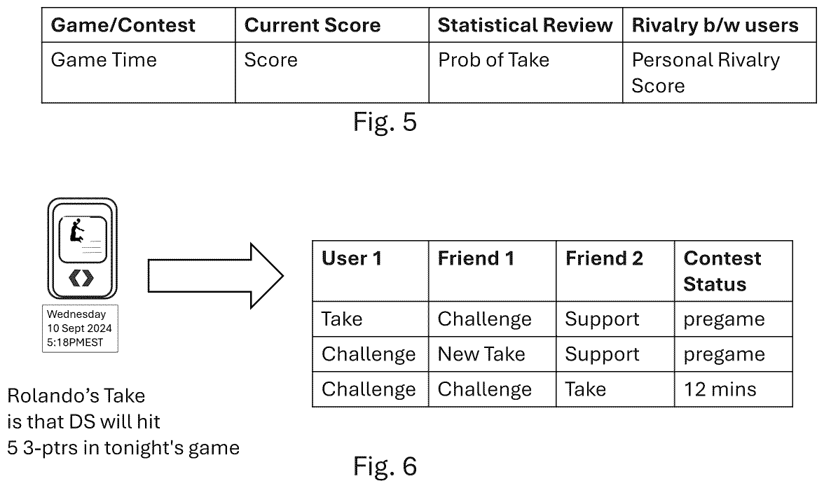

FIG. 5 depicts a data graph of game content that can be generated by the prompt generator and used in addition to data from the data graphs built by the social media application. In particular, FIG. 5 depicts that during the course of a game the prompt generator 320 can keep track of the game time, that is how many minutes of the game have been played, the number of quarters that are being played or have been played, whether or not halftime has been reached, whether or not the game is in overtime, and other indications of game time and gameplay. Current score measure can be maintained which indicates the score between the participants. A statistical review can be generated which indicates, at a particular time during gameplay, the likelihood that a Take made by a user, such as that Mr. Smith will make the necessary number of three pointers, is likely to be correct or incorrect. A Rivalry Between Users measurement can be taken, which indicates for a particular Take whether that Take is relevant to or similar to other Takes the user has made and which have been challenged by a friend in their network. This can indicate whether or not for a particular game a Take made by a user was challenged pregame or has been challenged during the game by friends in their network. Further, if a user and another user in their network have made opposing Takes in a number of contests previously, the system may prompt the user to make a Take previously made by the other user in their network in order to facilitate the continuation of the friendly rivalry between two friends. In these ways the system may identify opportunities for engagement which a user is more likely to find interesting and facilitate further engagement within the social media application by a user.

FIG. 6 further depicts a table that can be generated by the prompt generator which records the Takes and challenges or supports made by the user, indicated as user 1, and whether friends in the user's network have challenged or supported that Take, or whether the friends have entered new Takes and if so whether the user one has supported or challenged those Takes. FIG. 6 also indicates that the prompt generator can record into the table the contest status during the time that a Take or challenge was made such as during the pregame, or 12 minutes into gameplay. The information from tables of FIG. 5 and FIG. 6 can be employed by the prompt generator to build the prompt for the generative AI system to create content.

FIG. 7 indicates that the prompt generator will have a scheduler, and that scheduler will identify periods of time such as pregame, gameplay, and resolution. It is during these times that the prompt generator will create prompts for the generative AI system. In this way relevant data is created for the user at a time when the user has an interest in the game, as well as the Takes of his friends so that the content generated at that time will be of interest to the user as well as to the user's friends.

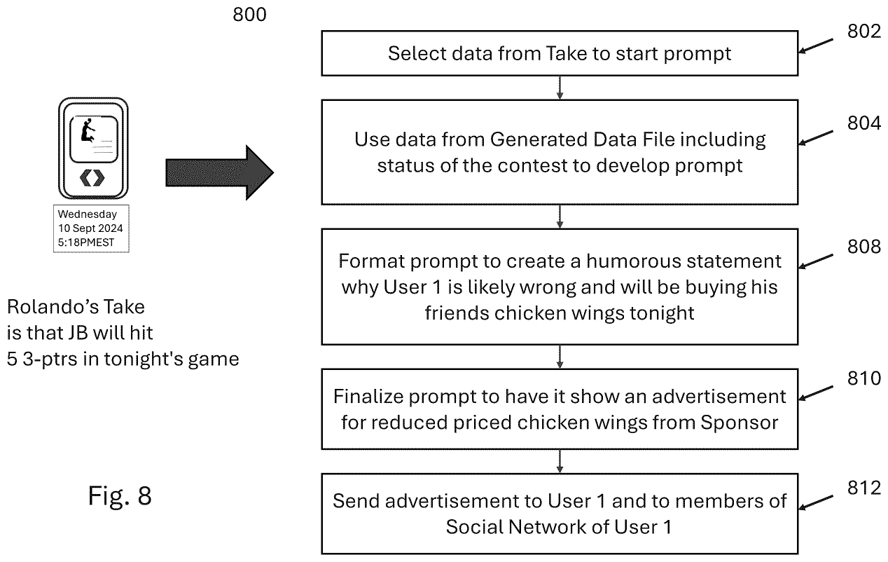

FIG. 8 depicts one process according to the systems and methods described herein for rapidly generating content that could be used for advertising in a social media application. In particular, FIG. 8 depicts a process 800 that begins in 802 by selecting data from a Take that has been entered by a user in order to start a prompt. The process 800 proceeds to 804 where the process 800 will use data from the Generated Data File (GDF) which includes the status of the contest, to develop a prompt for the generative AI system. The GDF comprises data from the Take, the user's data graphs of interests and social network, the status of the contest which the Take is regarding, and the Takes made by other users in the user's social network. The process then proceeds to 808 where it will format the prompt to create a prompt that directs the generative AI system to create engaging statements regarding an expected result of the user's Take in relation to Takes made by their friends. For example, if the user has made a Take which supports Mr. Tatum scoring 5 3-point baskets, and the GDF indicates that Mr. Tatum has scored no 3-point baskets, the gameplay has reached halftime, and another user within the user's social network has challenged the user's Take, at 808 the process will create a prompt that may direct the generative AI system to create a humorous prompt as to why the user is likely wrong in their Take and will be in this example, buying his friend's chicken wings tonight. Once the prompt is formatted in this draft form, the process proceeds to 810 wherein the prompt is finalized to direct the creation of content that will also show an advertisement for reduced priced chicken wings from the sponsor within the content being generated around the interests of the user. The process 800 proceeds to 812 where it will send the generated content, including the advertisement, to the user and selected members in the user's social network.

In another example, a user has made a Take which supports Mr. Tatus scoring 5 3-point baskets, and the GDF indicates that the gameplay has reached halftime, Mr. Tatum has already scored 5 3-point baskets, and a friend in the user's social network had made a Take challenging the user's Take. At 808 the process may then create a prompt that may direct the generative AI system to create a mini-game 814, such as a puzzle, which when completed displays an AI generated cartoon image of Mr. Tatum. The process proceeds to 810 which will include a prize for the mini-game 814 which will be a coupon for reduced price chicken wings from a sponsor. At 812 the user is sent the optional mini-game 814 with the prompt that they will win a prize for completing the game. When the user completes the mini-game 814, they are awarded the coupon and the friend who had challenged the user's take is sent a humorous prompt generated by the AI system indicating that their friend's opposing Take won them a prize.

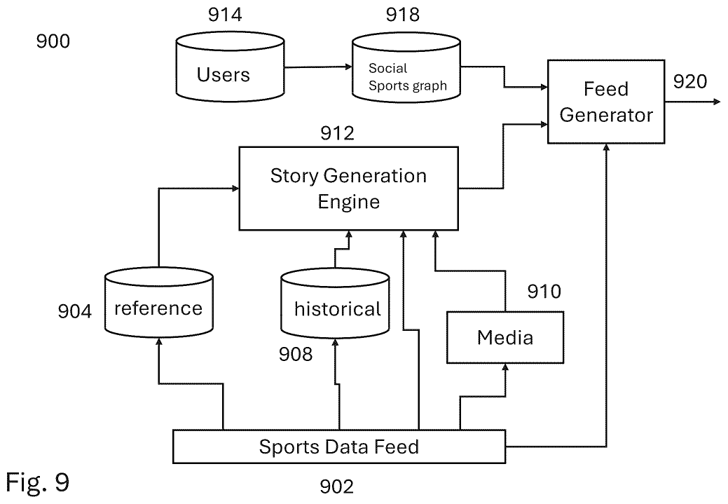

FIG. 9 depicts a block diagram of an embodiment of the system 900 which collects and processes data to generate content. The system 900 comprises a sports data feed 902, a reference data database 904, a historical database 908, a media database 910, a story generation engine 912, a users database 914, a social sports graph database 918 and a feed generator 920. To illustrate this embodiment, various illustrative components, blocks, modules, and steps have been described herein generally in terms of their functionality. Skilled artisans may implement the described functionality in varying ways for each particular application, but such implementation decisions should not be interpreted as causing a departure from the embodiments described herein. The sports data feed 902 consists of a stream of computer readable data representing live sports data which is communicated to and stored by the reference database 904, the historical database 908 and the media database 910. The sports data feed 902 provides live information such as individual player statistics, team statistics, and league statistics which are updated as contests within a particular sports league occur. The player statistics may include individual statistics such as points scored, rebounds, home runs, and other individual sports statistics. The team statistics may be cumulative totals of individual statistics for all players on the team, rate statistics such as average points scored per player, or team specific statistics such as team win/loss record. The sports data feed 902 may be of the type which is typically commercially available, such as SportRadar or other similar third-party providers of such live statistics streams. The statistics of individual players and teams will be sent to the reference database 904 for storage. The reference database 904 will maintain a record of individual players and team statistics for a shorter period, such as the last three or five contests. The database will delete the records of older contests once the record of a new contest has been stored in the reference database 904. This allows the system 900 to quickly access the most recent data about players and teams. The sports data feed 902 will send player, team, and league statistics to the historical database 908 for storage. The historical database 908 will store the statistics for a longer period, including the entire professional career of individual players, the past three or five years of team and league statistics. The historical database 908 may also store more complicated statistics such as matchup statistics between two individual players or between two teams in a league. This allows the system 900 to access a longer history of a sports league's data to generate compelling storylines which may be a part of a season long, or multiple season long story.

The sports data feed 902 may also provide media which can be used to generate content, such as photos of players taken during gameplay, team logos, headshots of players, and other such media. The sports data feed 902 sends the media to the media database 910 for storage. The sports data feed 902 may provide new media periodically, such as after each contest, or at a regular time interval such as daily or weekly updates. The media database 908 may be configured to analyze the incoming media from the sports data feed 902 to ensure the database has a sufficient variety and quality of images for each player and team within a league. The media database 908 may also be configured to replace the media it has stored for a particular player or team with newer media to ensure the media is timely and up to date. The media database 908 can be accessed by the story generation engine 912 when it is generating content about a particular player or team to utilize relevant media in the generated content. In this way the system 900 may include relevant and interesting media within the content generated by the system 900.

The story generation engine 912 can access the reference database 904, the historical database 908 and the media database 910, and the sports data feed 902 directly to generate relevant and timely content or the system 900. The story generation engine 912 may analyze the data stored in the historical database 908 to create a prediction for an outcome in an upcoming contest which has a statistical likelihood close to 50%, such that is essentially as likely to occur as to not occur. The story generation engine 912 may predict outcomes such as whether a particular player will score enough points to reach a threshold in an upcoming game, if one player will score more points than another player, or if a team will collectively score a total amount of points above a particular threshold. The story generation engine 912 may also determine that certain predictions will be interesting even if they are not essentially as likely to occur as to not occur when they are relevant to a compelling storyline, such as when a team must win in order to proceed to the playoffs, or if a particular player has a notable hitting streak which may or may not continue. When the story generation engine 912 determines that an outcome for a particular player or team will likely be an interesting prediction, the story generation engine 912 will access the media database 910 to select relevant media for the player or team in question. The story generation engine 912 will access the reference database 904 to include the recent performance of the player or team in question for the relevant statistics to provide context to a user. In this way the story generation engine 912 may generate interesting predictions and can present them with relevant statistical context and media so a user may easily understand the question being posed and the context around which it is being asked.

The users database 914 stores information regarding users such as their past predictions, the results of the predictions, their favorite teams and players, other users they are connected to, the username and other such information. The social sports graph 918 can access the users database 914 to analyze the level and type of connection between various users. For example, there may be a set of users who are each have a mutual connection with another user, and who each have the same favorite team. In another example a group of users may all be directly connected to each other. In yet another example there may be a set of users who are not connected directly or indirectly, but share the same favorite teams and players and consistently make similar predictions. The social sports graph 918 analyzes these types of connections between users to identify a community of users with shared interests, and which other user's activity may be interesting to other users in the users database 914. The social sports graph 918 may also analyze the connections between users and the similarities in their predictions to help determine what predictions may be more or less interesting to a particular user.

The feed generator 920 receives the content made by the story generation engine 912 and the user analysis from the social sports graph 918 in order to generate a stream of interesting predictions for a particular user. The feed generator 920 may also access the sports data feed 902 to include live updates of particular contests within the feed provided to a user. The feed generator 920 is configured to analyze the content from the story generation engine 912 and the user information from the social sports graph 918 in order to determine which predictions will be most interesting to a user. The feed generator 920 may also determine that the connections between two users are sufficient that each will want to know about the predictions of the others. The feed generator 920 is configured to compile the generated content, the information regarding other users, and live sports information from the sports data feed 902 to generate a stream of content which will likely be compelling to a user. In this way the system 900 is configured to provide a user with predictive questions, live sports data, and the activity of other users which will be most compelling to that user.

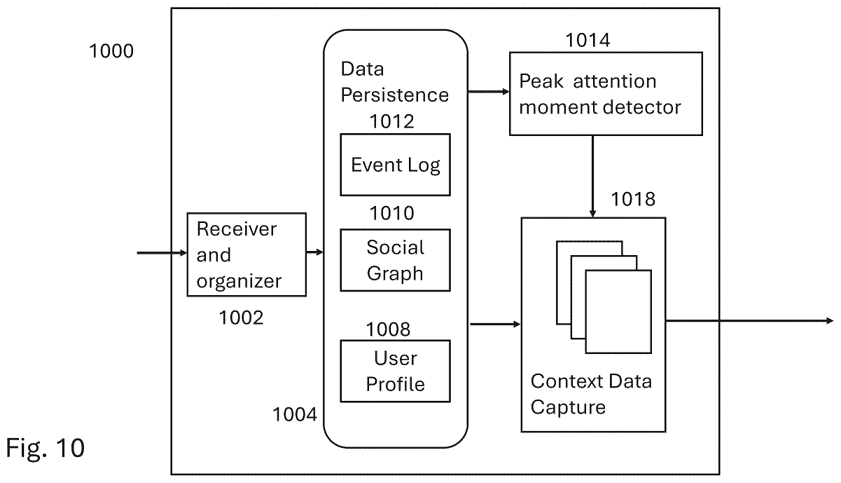

FIG. 10 depicts a block diagram of an embodiment of a system 1000 for identifying an event which is likely to be engaging to a particular user. The system 1000 includes a receiver and organizer 1002, a user data filter 1004, a user profile 1008, a user's social graph 1010, an event log 1012, a peak attention moment detector 1014 and a context data capture node 1018. In one or more aspects, the functions described may be implemented in hardware, computer software, firmware, or in any combination thereof. Implementations of the subject matter described in this specification also can be implemented as one or more computer programs, i.e., one or more modules of computer program instructions, encoded on a computer storage media for execution by, or to control the operation of, data processing apparatus. The system 1000 in the depicted embodiment operates as an event detector node. The receiver and organizer 1002 collects signals representing events occurring during a live sports game and the activity of users on the social media application. The receiver and organizer then itemizes and transmits the received signals to the user data filter 1004 which analyzes the relevance of the events for a particular user. The user data filer 1004 analyzes the relevance by accessing the user profile 1008, which includes the teams and players a user has identified as their favorites. The user profile 1008 also includes the other users which the user is connected to and other groups or interests the user has joined or identified as their interest. The user data filter 1004 further includes the user's social graph 1010 which is created based on the direct and indirect connections between the user and other users of the system as well as any users otherwise unconnected to the user which have sufficient similarity in interest, location, and activity. The user data filter 1004 also includes the event log 1012 which records the activity of the user in the past including previous predictions made by the user, the timing and location at which the predictions were made, and previous reactions of the user to various prompts from the system. The user data filter 1004 uses the information from the user profile 1008, the user's social graph 1010, and the event log 1012 to generate a filter for the events which represents a real-time model of the user's interests. The filter generated by the user data filter 1004 is used to determine which of the events sent by the receiver and organizer 1002 will be interesting to a user and to determine what type of prompt will most likely result in engagement by the user. In this way the system 1000 is able to determine what topics or events will likely be interesting to a particular user based on their identified interests, past activity, and relationships to other users.

The events which would be relevant to a particular user are then processed by the peak attention moment detector 1014. The peak attention moment detector 1014 is an artificial intelligence program which has been trained to analyze events which occur during a sports game and the engagement of viewers in response to those events to determine what types of events capture the attention of viewers. For example, the peak attention moment detector 1014 may determine that when there is a lead change in a sports game, there is a higher level of engagement on social media of fans of one of the teams. The peak attention moment detector 1014 may also be trained to identify when fans of a particular player will be highly interested in the events, such as when a player with a notable hitting streak is on their last at-bat during a baseball game. The system 1000 applies the peak attention moment detector 1014 to analyze the events sent from the receiver and organizer 1002 and processed by the user data filter 1004 to determine if an event which is deemed to be relevant to a particular user's interest is also likely to be a highly engaging moment for that user. When the peak attention moment detector 1014 determines that an event is relevant and likely to be highly engaging for a user, a peak attention signal is generated by the peak attention moment detector.

The events will also be analyzed by the context data capture node 1018 which evaluates the context around the events to determine the type of prompt which will most likely result in engagement by the user. The context data capture node 1018 uses information such as the time of day, the day of the week, the physical location of the user, the type of prompt which could be sent and the branding or group which will be the source of the prompt to determine a method of prompting the user which will most likely result in engagement. The context data capture node 1018 is an artificial intelligence program trained to analyze the events which the user data filter 1004 identifies as likely to be interesting to a user and the potential source of a prompt to determine a method, timing, and language of a prompt which will likely produce engagement by the user. For example, the context data capture node 1018 may receive from the user data filter 1004 a lead change in a basketball game for a user's favorite team, and the peak attention moment detector 1014 may indicate that this is the type of event which is likely to be highly engaging. Continuing with the example, the event may occur at Friday at 7:35 pm and the user's location data indicates the user is present at a bar which operates a club for users of the program which this user has joined. The context data capture node 1018 may determine that the best way to prompt the user for engagement would be to notify the user with an offer for reduced price drinks. In a different example, the context data capture node 1018 may identify that the user's location data indicates they are likely at home for a Monday night game. In that case, the context data capture node 1018 may determine that it would be better to prompt the user to order delivery from a particular restaurant. In this way the system 1000 applies the context data capture node 1018 to determine, when an event which is likely to produce engagement occurs which aligns with a user's interests, what type of engagement a user is likely prepared to perform.

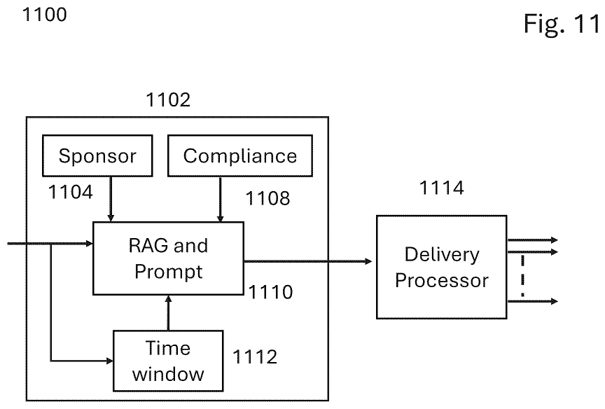

FIG. 11 depicts a block diagram of an embodiment for generating an engaging prompt for a user. The system 1100 comprises a prompt curation stage 1102, a sponsor filter 1104, a compliance filter 1108, a prompt generator 1110, a time window 1112, and a delivery processor 1114. After the processes depicted in FIG. 10 have determined that a moment of peak engagement has occurred for a particular user, and evaluated the type of prompt which is most likely to engage that user, the system 1000 sends this information to the system 1100. The system 1100 receives as input a description of the type of prompt which will likely result in engagement, and proceeds to the prompt curation stage 1102. The prompt curation stage 1102 includes a sponsor filter 1104 and a compliance filter 1108. The sponsor filter 1104 provides the prompt generator 1110 with information on the stylistic desires of a particular sponsor which would like to engage the user. For example, some restaurant brands have a recognizable style in their marketing which they would like reflected in any prompts to their customers. Depending on the organization which would like to engage the user, this filter may include significant restrictions on the language which may be used, require certain images and media, or require the prompt to sound like it is being sent from an organization's mascot. The compliance filter 1108 provides information on what regulatory or essential restrictions any prompt must follow. For example, there may be government regulation on the types of language which can be associated with sports gambling prompts. The compliance filter 1108 ensures that any communication with a user is in compliance with these regulations. In another example, some organizations may have strict limitations on associating their brands with alcohol, so the compliance filter will require any communication to a user to refrain from any mention of alcohol.

The prompt curation stage 1102 will utilize a prompt generator 1110 which applies an artificial intelligence based large language model to generate a prompt for a user which is likely to engage that user. The prompt generator 1110 may utilize Retrieval Augmentation Generation methods to optimize the output of the large language model and incorporate the limitations from the sponsor filter 1104 and the compliance filter 1108. The prompt generator 1110 will also be limited by the time window 1112 which determines a short window of time during which prompting the user will remain sufficiently effective. The time window 1112 will require the system 1100 to produce the prompt within a short period after the event identified by the system of FIG. 10 occurs, which may be between thirty and ninety seconds, typically forty-five seconds. If the prompt curation stage 1102 determines a prompt from the prompt generator 1110 is in violation of any of the sponsor filter 1104, the compliance filter 1108 or the time window 1112 requirements, the system may determine that no prompt should be sent. If the prompt is produced within the constraints of the prompt curation stage 1102, then the system proceeds to delivery processor 1114. The delivery processor 1114 performs the necessary final processing to send the generated prompt to a user. For example, if the system 1100 has generated a Take as the best method of prompting the user, the delivery processor 1114 will perform the necessary processing to place the Take in the user's feed and will send a notification to the user's mobile device that a new Take is available. In another example, if the system 1100 has generated an email as the prompt, the delivery processor 1114 will ensure that an email from the intended sender is sent to an email associated with the user.

The person skilled in the art will understand that the Figures herein, including FIGS. 9-11, utilize functional block diagrams to illustrate functions which typically represent portions of computer code capable of carrying out the functions attributed to the illustrative blocks. The databases described herein can be conventional databases either a propriety database or a cloud-based computing service of the type offered by AWS. The AI applications, such as the user data filter 1004 and the RAG LLM can be of the type which is commercially available, such as products offered by OpenAI, Claude, and other products typical in the field of Artificial Intelligence.

Accordingly, it will be understood that the invention is not to be limited to the embodiments disclosed herein and extend to the subject matter of the claims herein.

1. Systems for generating advertising content for a social media application, comprising
a social media application having a processor configured to:
generate a network of relationships that records interconnections between the users of the social media application, where each user has a set of recorded interests,
process the network of relationships to generate a dynamic user data filter having a time-varying model of a real-time interest of a user,
monitor a real-time signal stream having signals representing events related to a sporting competition,
an event detection node configured to apply the user data filter to the real-time signal stream to identify a set of signals representing an event which will interest the user at the time the event was detected to generate a peak attention signal,
a prompt generator configured to process the peak attention signal to generate one or more prompts to a generative AI system, wherein the one or more prompts are contemporaneous with the time of the peak attention signal and based on the interests of the user and a second user who is part of the network of relationships of the user, and
the generative AI system is configured to generate engaging content in response to the prompt and that content can be joined to advertising information.

2. The systems of claim 1 including an attention profiler for setting an attention value curve for a sports competition indicating a level of interest of a user for the sports competition.

3. The systems of claim 1 further including a message timer triggered by an event occurring during the sports competition and indicating a time window for delivering advertising content to the user.

4. The systems of claim 1 including a contest monitor that monitors while a contest is still unresolved and sends the generated content during that time and not after.

5. The systems of claim 2, wherein the contest is a sporting event and unresolved means there is not a final score.

6. The systems of claim 1 wherein the prompt generator generates prompts to create ad content based on the known arc of the sporting contest, including early leads, leading by a substantial amount, arising comebacks, chokes and final winner.

7. The systems of claim 1 wherein the prompt generator includes a projection processor to project the probability of an outcome based on a current state of a contest.

8. The systems of claim 1, further comprising a network processor for identifying friends in the network of relationships to receive the advertising content.

9. The systems of claim 1, further comprising a content analyzer to analyze a generated ad and measure whether the generated ad is related to a conversation or a back and forth, that occurred between users in a network of relationships.

10. The systems of claim 1 where the prompt generator analyzes past user activity stored in the data graphs to determine an advantageous time to prompt a user with a query related to a topic they have an interest in.

11. The systems of claim 1 where the prompt generator generates a minigame for a user based on the peak attention signal, which will provide the user with a prize when the minigame is completed.

12. The systems of claim 1 where the curation node is further configured to analyze contextual data to generate the peak attention signal.

13. The systems of claim 12 where the contextual data includes a time contemporaneous to the data which produced the signal and data which indicates the physical location of the user.

14. A method for generating engaging social media content comprising,
generating a network of relationships between users of a social media application based on interconnections between the users, previous activity of each user, and shared interests which the users have identified,
analyzing the network of relationships to generate a user data filter representing the real-time interest of a user,
monitoring a real-time signal stream representing events in a sporting contest, analyzing the real-time signal stream of live sports data to identify moments within the real-time signal stream which represent engaging moments in the sports contest,
analyzing the engaging moments with the user data filter to identify one of the engaging moments which is relevant to a particular user,
generating a prompt for a generative artificial intelligence application based on the identified engaging moment user,
generating engaging content based on the prompt, and
presenting the content to the particular user.

15. The method of claim 14 where analyzing the engaging moments further comprises determining if a user is likely to engage with generated content at a time contemporaneous to when it is generated and at a place where the user is located.

16. The method of claim 14 where analyzing the stream of live sports data further comprises monitoring a status of a sports contest and generating the content before the contest is complete and not after.

17. The method of claim 14 where generating a prompt for a generative artificial intelligence application further comprises generating a prompt based on a known arc of a sports contest.

18. The method of claim 14 where generating a prompt for a generative artificial intelligence further comprises predicting the outcome of an event within a sports contest.

19. The method of claim 14 where presenting the content to a particular user further comprises presenting the content to a second user within the network of relationships.

20. The method of claim 14 where generating engaging content further comprises generating a minigame which the user can play for a prize.
